(19) United States
(12) Patent Application Publication
(10) Pub. No.: US 2023/0063083 A1
(43) Pub. Date: Mar. 2, 2023

(54) HANDHELD SIGN WITH WARNING SYSTEM

(71) Applicant: THEORY STRINGER, DELTONA, FL (US)

(72) Inventor: THEORY STRINGER, DELTONA, FL (US)

(21) Appl. No.: 17/803,173

(22) Filed: Aug. 27, 2021

(51) Int. Cl. G08B 5/00

(52) U.S. Cl. CPC G08B 5/006

(57) ABSTRACT

A handheld warning sign including front and back with at least one side having a predetermined color and warning information. A handle member of predetermined length is fastened to the bottom of the sign member enabling it to be handheld. A longer pole extension structure can be attached to the sign handle member enabling it to extend to the ground allowing the sign unit to be used a handheld road sign. An electronic sound device positioned within the handle member of the sign is connected to a battery and a off and on power switch on the handle member. When the sound device button on the handle member is pressed, the electronic sound device produce a warning sound such as a whistle, siren or other warning sounds to attract the attention of motorists or pedestrians so that they can safely follow the directions the safety personnel.

### RELATED APPLICATIONS

The present application is related to U.S. patent No. 63/070,810, issued Aug. 26, 2020, for HANDHELD SIGN DEVICE WITH WARNING SYSTEM, by Theory (Theotis) Stringer, included by reference herein.

### FIELD OF THE INVENTION

The present invention relates, to hand-held signs and, more particularly, this invention relates to handheld signs having a battery powered electronic sound device that when activated emits an electronic warning sound such as a whistle, siren, or other electronic sounds to aid in controlling traffic and warning motorist and pedestrians near constructions sites, intersections, schools zones and other area where pedestrians cross roadways.

### BACKGROUND OF THE INVENTION

Prior to the conception and development of the present invention, safety personnel such as traffic police, school crossing guards, and construction workers, have used handheld signs to direct and to and pedestrian traffic and to help children safely cross streets and intersections. Sometimes motorist are distracted on roadways near intersections, school zones, construction sites, and places where children and pedestrians cross roadways endangering the lives of other motorist and especially pedestrians.

Traffic officers, flagmen, and school crossing guards, often use whistles along with handheld signs to aid in controlling traffic and helping children and other pedestrians safely cross at dangerous intersections and roads around schools by blowing whistle warning sounds to alert motorist to “STOP,” when pedestrians are about to cross the road. However because of a concern that blowing air through a whistle around others increases the chances of spreading germs and other infectious bacteria into the air, many agencies require masks to be worn by these safety personnel. Since masks are now required, it is not practical to use a traditional whistle around kids and pedestrians because of the mask requirement.

There have been some improvements made on handheld signs by adding battery powered lights to the signs to better alert and warn drivers and pedestrians at intersections, in road constructions areas, and school crossings for safer traffic control as seen in prior art US20070209255A1, U.S. Pat. No. 6,409,358B1, and U.S. Pat. No. 9,153,149B1

Also because of the mask requirements, some state and county agencies have implemented the use of handheld electronic whistles instead of traditional whistles for safety personnel.

A short coming of using a handheld electronic whistle is that the safety personnel's directing hand is no longer always free when performing their duties.

Although the battery powered light sign is a good improvement over the standard handheld sign for warning motorist and pedestrians, the visual effects of this sign is not as effective as the piercing sound of a whistle or other electronic sounds in arresting the motorist and pedestrians attention.

It is therefore an object of the invention to provide a handheld sign that can emit electronic generated sounds such as a whistle, horn, siren, or other electronic sounds to warn and assist pedestrians in safely crossing roads and intersections.

It is another object of the invention to provide a handheld sign that can emit electronic generated sounds for the use of traffic control.

It is another object of the invention to provide a handheld sign that can emit electronic generated sounds without the operator spreading germs into the air by blowing a whistle.

It is another object of the invention to provide a handheld sign that can emit electronic generated sounds that can be held in one hand by the operator enabling their other hand to always be free to direct traffic and pedestrians.

It is another object of the invention to provide a handheld sign to better assist safety personel in traffic control.

### SUMMARY OF THE INVENTION

In accordance with the present invention, there is provided a light-weight handheld sign that displays regulatory information on one or both sides of the sign expanse. A handle member securely connected to the bottom of the sign enabling it to be held with one hand. A pole extension structure can be attached to the sign's handle member enabling the base to stand on the ground and held by the hand as a pole sign. An electronic sound device powered by at least one rechargeable, or disposable battery and positioned inside the the sign's handle member or pole structure. An “on and off” power switch on the handle member controls the power flow from the battery to the electronic sound device. When pressed, the sound device button on the handle member enables the electronic sound device to emit a warning sound such as a whistle, siren or other electronic sounds to warn motorists or pedestrians.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a stop/slow handheld sign device with warning system displaying the stop side of the sign according to a presently preferred embodiment of the present invention;

FIG. 2 is a rear view of a stop/slow handheld sign according to a presently preferred embodiment of the present invention;

FIG. 3 is a front view of a sign with pole extention according to a presently preferred embodiment of the present invention;

FIG. 4 is a rear view of a sign with pole extention;

FIG. 5 is a right view of a handheld sign handle member;

FIG. 6 is a front exploded view of a handheld sign handle member with electronic sound device; and

FIG. 7 is a bottom perspective view of a handheld sign handle member showing the sound vent.

For purposes of clarity and brevity, like elements and components will bear the same designations and numbering throughout the Figures.

### DESCRIPTION OF THE PREFERRED EMBODIMENT

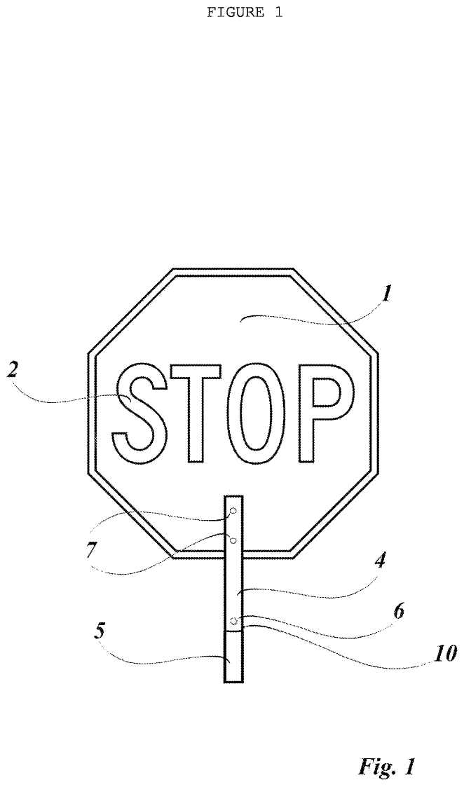

FIG. 1 is a front view of a handheld sign 1 showing the regulatory information—stop 2 on the front expanse of Sign 1 Sign 1 is connected to the handle member 4 with fasteners 7 A handle grip 5 is secured to the handle member 4 to comfortably hold sign 1 with hand. An electronic sound device 9 having at least one battery 12 is located inside handle member 4. Power switch 10 is connected to the electronic sound device 9 and when power switch 10 is in the ON position it sends power from the battery 12 to the electronic sound device 9. Sound device button 6 is mounted on the handle member 4. When the sound device Button 6 is pressed, it emits a warning sound such as a whistle or other electronic sounds.

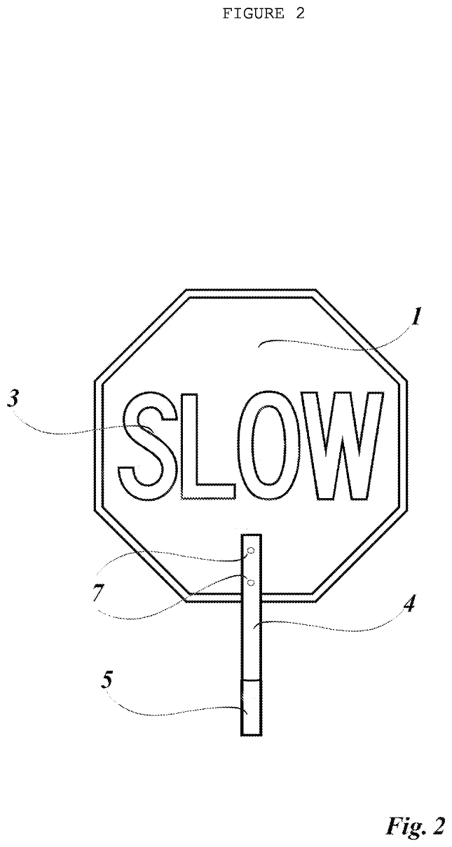

FIG. 2 is a rear view of a handheld sign 1 showing the regulatory information—Slow 3 on the rear expanse of Sign 1. Sign 1 is connected to the handle member 4 with fasteners 7. A handle grip 5 is secured to the handle member 4 to comfortably hold sign 1 with hand. An electronic sound device 9 having at least one battery 12 is located inside handle member 4. A sound device button 6 is mounted on the handle member 4 to activate the battery 12 powered electronic sound device 9. When power switch 10 is in the ON position and sound device button 6 is pressed, the electronic sound device 9 emits a warning sound such as a whistle or other electronic sounds.

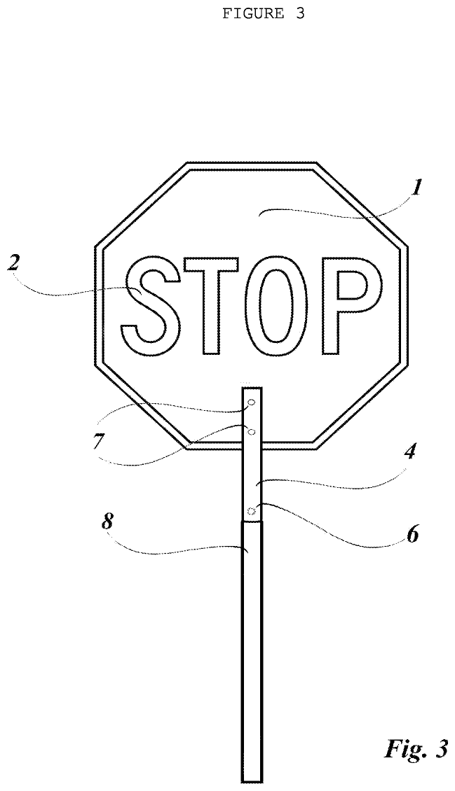

FIG. 3 is a front view of a sign 1 having the regulatory instruction—stop 2 on the front expanse of the sign 1. Sign 1 is connected to the handle member 4 with fasteners 7. A Pole Extension 8 is connected to the handle member 4 with fasteners 7 allowing sign 1 to stand on the ground and held with one hand. A battery 12 powered electronic sound device 9 is located inside handle member 4. A sound device button 6 is located on the handle member 4 and is connected to the battery 12 powered electronic sound device 9. When power switch 10 is in the ON position and sound device button 6 is pressed, the electronic sound device 9 emits a warning sound such as a whistle or other electronic sounds.

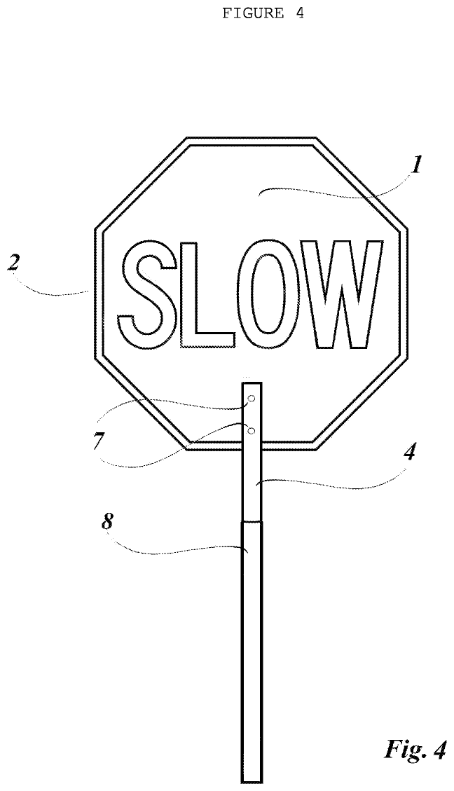

FIG. 4 is a rear view of a sign 1 having the regulatory instruction—Slow 3 on the rear expanse of the sign 1. Handle member 4 is fastened to the sign 1 with fasteners 7. A Pole Extension 8 is connected to the handle member 4 extending the handle allowing the sign 1 assembly to stand on the ground and held with one hand. An electronic sound device 9 connected to a rechargeable battery 12 or other power source inside the handle member 4 is activated by pressing the sound device button 6 located on handle member 4 of sign 1.

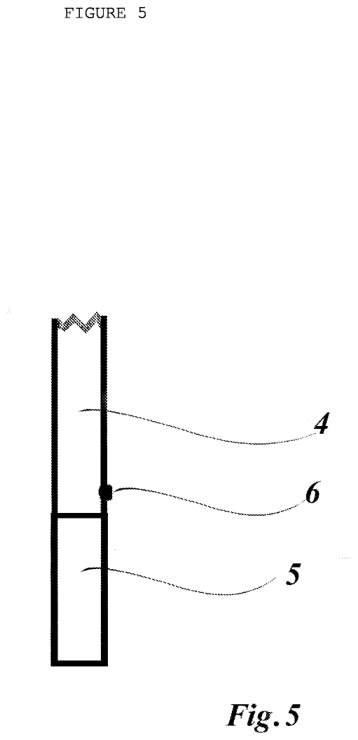

FIG. 5 is a right side view of the handheld sign 1 handle member 4 with handle grip 5 showing the sound device button 6 located on handle member 4.

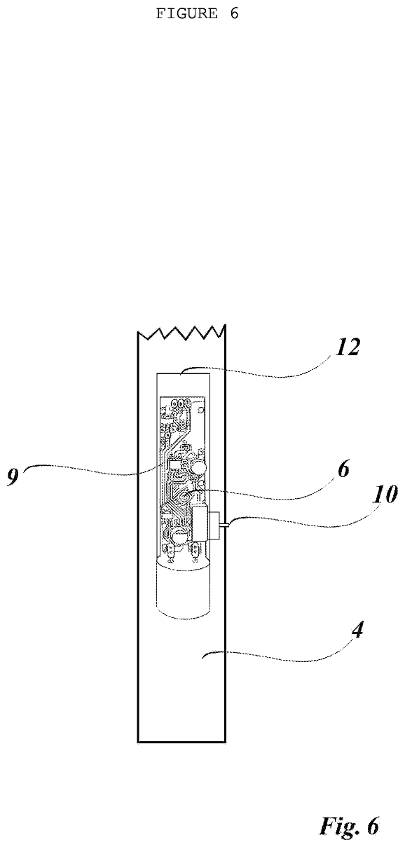

FIG. 6 is a front exploded view of the handheld sign 1 handle member 4 showing a battery 12, electronic sound device 9 connected to sound device button 6 on handle member 4. The power switch 10 is connected to the electronic sound device 9 and when the power switch 10 is in the ON position it sends power from the battery 12 to the electronic sound device 9. And when sound device button 6 is pressed the electronic sound device 9 emits a warning sound such as a whistle, siren, or other warning sounds.

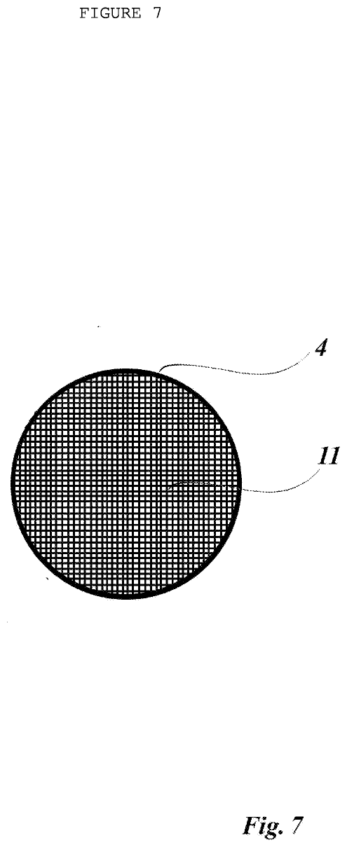

FIG. 7 is a bottom perspective of the handheld Sign 1 showing the sound vent 11 at the bottom on handle member 4 that allows the warning sounds such as a whistle, siren, or other electronics sounds to pass through the handle member 4 when power switch 10 is in the ON position and the sound device button 6 is pressed.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A handheld sign device with warning system, comprising:
means for aiding safety personnel in controlling motorist traffic in construction areas, intersections, schools zones and other areas where pedestrians cross roadways;
means for securing handle member to sign, rigidly connected to said means for aiding safety personnel in controlling motorist traffic in construction areas, intersections, schools zones and other areas where pedestrians cross roadways;
means for providing regulatory information to vehicle traffic and pedestrians to stop;
means for providing regulatory information to vehicle traffic and pedestrians to slowly proceed;
means for attracting the attention of automobile drivers and pedestrians and aiding in directing road and pedestrian traffic by emitting an electronic warning sound such as a whistle, siren, and other warning sounds when the electronic sound device is engaged;
means for hand support for the sign and providing a structure for the electronic sound device, rigidly connected to said means for securing handle member to sign;
means for providing a comfortable grip for the hand while holding the sign, rigidly connected to said means for hand support for the sign and providing a structure for the electronic sound device;
means for extending the handle member so allowing it to stand on the ground and held as a pole sign, rigidly connected to said means for hand support for the sign and providing a structure for the electronic sound device;
means for activates the electronic sound device when pressed when power switch is on, rigidly connected to said means for attracting the attention of automobile drivers and pedestrians and aiding in directing road and pedestrian traffic by emitting an electronic warning sound such as a whistle, siren, and other warning sounds when the electronic sound device is engaged;
means for allows electronic warning sounds to pass through handle member when electronic sound device is activated, rigidly connected to said means for attracting the attention of automobile drivers and pedestrians and aiding in directing road and pedestrian traffic by emitting an electronic warning sound such as a whistle, siren, and other warning sounds when the electronic sound device is engaged;
means for turning the electronic sound device on and off, rigidly connected to said means for hand support for the sign and providing a structure for the electronic sound device; and
means for giving power to the electronic sound device, rigidly connected to said means for turning the electronic sound device on and off, and rigidly connected to said means for activates the electronic sound device when pressed when power switch is on.

2. The handheld sign device with warning system in accordance with claim 1, wherein said means for aiding safety personnel in controlling motorist traffic in construction areas, intersections, schools zones and other areas where pedestrians cross roadways comprises a sign.

3. The handheld sign device with warning system in accordance with claim 1, wherein said means for securing handle member to sign comprises a fasteners.

4. The handheld sign device with warning system in accordance with claim 1, wherein said means for providing regulatory information to vehicle traffic and pedestrians to stop comprises a stop.

5. The handheld sign device with warning system in accordance with claim 1, wherein said means for providing regulatory information to vehicle traffic and pedestrians to slowly proceed comprises a slow.

6. The handheld sign device with warning system in accordance with claim 1, wherein said means for attracting the attention of automobile drivers and pedestrians and aiding in directing road and pedestrian traffic by emitting an electronic warning sound such as a whistle, siren, and other warning sounds when the electronic sound device is engaged comprises an electronic sound device.

7. The handheld sign device with warning system in accordance with claim 1, wherein said means for hand support for the sign and providing a structure for the electronic sound device comprises a handle member.

8. The handheld sign device with warning system in accordance with claim 1, wherein said means for providing a comfortable grip for the hand while holding the sign comprises a handle grip.

9. The handheld sign device with warning system in accordance with claim 1, wherein said means for extending the handle member so allowing it to stand on the ground and held as a pole sign comprises a pole extension.

10. The handheld sign device with warning system in accordance with claim 1, wherein said means for activates the electronic sound device when pressed when power switch is on comprises a sound device button.

11. The handheld sign device with warning system in accordance with claim 1, wherein said means for allows electronic warning sounds to pass through handle member when electronic sound device is activated comprises a sound vent.

12. The handheld sign device with warning system in accordance with claim 1, wherein said means for turning the electronic sound device on and off comprises a power switch.

13. The handheld sign device with warning system in accordance with claim 1, wherein said means for giving power to the electronic sound device comprises a battery.

14. A handheld sign device with warning system, comprising:
a sign, for aiding safety personnel in controlling motorist traffic in construction areas, intersections, schools zones and other areas where pedestrians cross roadways;
a fasteners, for securing handle member to sign, rigidly connected to said Sign;
a stop, for providing regulatory information to vehicle traffic and pedestrians to stop;
a slow, for providing regulatory information to vehicle traffic and pedestrians to slowly proceed;
an electronic sound device, for attracting the attention of automobile drivers and pedestrians and aiding in directing road and pedestrian traffic by emitting an electronic warning sound such as a whistle, siren, and other warning sounds when the electronic sound device is engaged;
a handle member, for hand support for the sign and providing a structure for the electronic sound device, rigidly connected to said Fasteners;
a handle grip, for providing a comfortable grip for the hand while holding the sign, rigidly connected to said Handle Member;
a pole extension, for extending the handle member so allowing it to stand on the ground and held as a pole sign, rigidly connected to said Handle Member;
a sound device button, for activates the electronic sound device when pressed when power switch is on, rigidly connected to said Electronic Sound Device;
a sound vent, for allows electronic warning sounds to pass through handle member when electronic sound device is activated, rigidly connected to said Electronic Sound Device;
a power switch, for turning the electronic sound device on and off, rigidly connected to said Handle Member; and
a battery, for giving power to the electronic sound device, rigidly connected to said Power Switch, and rigidly connected to said Sound Device Button.

15. A handheld sign device with warning system, comprising:
a sign, for aiding safety personnel in controlling motorist traffic in construction areas, intersections, schools zones and other areas where pedestrians cross roadways;
a fasteners, for securing handle member to sign, rigidly connected to said Sign;
a stop, for providing regulatory information to vehicle traffic and pedestrians to stop;
a slow, for providing regulatory information to vehicle traffic and pedestrians to slowly proceed;
an electronic sound device, for attracting the attention of automobile drivers and pedestrians and aiding in directing road and pedestrian traffic by emitting an electronic warning sound such as a whistle, siren, and other warning sounds when the electronic sound device is engaged;
a handle member, for hand support for the sign and providing a structure for the electronic sound device, rigidly connected to said Fasteners;
a handle grip, for providing a comfortable grip for the hand while holding the sign, rigidly connected to said Handle Member;
a pole extension, for extending the handle member so allowing it to stand on the ground and held as a pole sign, rigidly connected to said Handle Member;
a sound device button, for activates the electronic sound device when pressed when power switch is on, rigidly connected to said Electronic Sound Device;
a sound vent, for allows electronic warning sounds to pass through handle member when electronic sound device is activated, rigidly connected to said Electronic Sound Device;
a power switch, for turning the electronic sound device on and off, rigidly connected to said Handle Member; and
a battery, for giving power to the electronic sound device, rigidly connected to said Power Switch, and rigidly connected to said Sound Device Button.
